(19) United States
(12) Patent Application Publication
(10) Pub. No.: US 2013/0314583 A1
(43) Pub. Date: Nov. 28, 2013

(54) WAFER LEVEL CAMERA MODULE ARRAY

(71) Applicant: Nai-Yuan Tang, Tainan City (TW)

(72) Inventor: Nai-Yuan Tang, Tainan City (TW)

(73) Assignee: HIMAX TECHNOLOGIES LIMITED, Tainan City (TW)

(21) Appl. No.: 13/477,823

(22) Filed: May 22, 2012

(51) Int. Cl. H04N 5/232

(52) U.S. Cl. 348/345; 348/E05.055

(57) ABSTRACT

A wafer level camera module array including a plurality of camera modules is provided. Each of the camera modules includes a back focus control layer. Each of the back focus control layer has the same thickness and includes a first control layer and a second control layer. The first control layer has a first refractive index, and the second control layer has a second refractive index different form the first refractive index. For the plurality of back focus control layers, the first thickness of the first control layer of at least one back focus control layer is different from the first thicknesses of the first control layers of the other back focus control layers. Alternatively, the second thickness of the second control layer of the at least one back focus control layer is different from the second thicknesses of the second control layers of the other back focus control layers.

### BACKGROUND OF THE INVENTION

1. Field of the Invention

The invention relates to a camera module array, and more particularly to a wafer level camera module array.

2. Description of Related Art

In modern electronics, wafer level camera modules are widely used in cell phones and portable devices. Thanks to the progress of technology, it is convenient and capable of fabricating a plurality of wafer level camera modules by assembling different optical elements or layers to form an array and cutting into many individual camera modules for mass production. Moreover, a multi-lens camera module, such as a three dimensional (3D) camera, may be fabricated by applying the fabricating method mentioned above as well.

However, in manufacturing, each of lenses in the array may have different back focus requirement to form a camera module with other optical elements due to the different design or different fabricating process. Therefore, individual adjustment of each camera modules in the array during the fabrication may be required for a suitable back focal length. Thus, fabrication difficulty and fabrication cost are increased.

### SUMMARY OF THE INVENTION

The invention is directed to a wafer level camera module array which is capable of having the same back focal length of a plurality of camera modules and reducing fabrication difficulty and fabrication cost.

The invention provides a wafer level camera module array including a plurality of camera modules. Each of the camera modules includes a back focus control layer. Each of the back focus control layer has the same thickness and includes a first control layer and a second control layer. The first control layer has a first thickness and a first refractive index, and the second control layer has a second thickness and a second refractive index different form the first refractive index. For the plurality of back focus control layers, the first thickness of the first control layer of at least one back focus control layer is different from the first thicknesses of the first control layers of the other back focus control layers. Alternatively, the second thickness of the second control layer of the at least one back focus control layer is different from the second thicknesses of the second control layers of the other back focus control layers.

According to an exemplary embodiment of the invention, for the plurality of back focus control layers, the first thickness of the first control layer of the at least one back focus control layer is different from the first thicknesses of the first control layers of the other back focus control layers, and the second thickness of the second control layer of the at least one back focus control layer is different from the second thicknesses of the second control layers of the other back focus control layers.

According to an exemplary embodiment of the invention, for the plurality of back focus control layers, a sum of the first thickness of the first control layer and the second thickness of the second control layer of one back focus control layer is substantially equal to a sum of the first thickness of the first control layer and the second thickness of the second control layer of another back focus control layer.

According to an exemplary embodiment of the invention, for each of the back focus control layers, a sum of the first thickness of the first control layer and the second thickness of the second control layer is substantially equal to the thickness of the back focus control layer.

According to an exemplary embodiment of the invention, each of the wafer level camera modules further includes a lens layer and a sensor layer. The lens layer is disposed on the back focus control layer, and the sensor layer disposed is under the back focus control layer. The lens layer images an image on the sensor layer through the back focus control layer, and the back focus control layer adjusts a back focal length of the camera module.

Based on the above description, by disposing and adjusting the first thickness of the first control layer and the second thickness of the second control layer of each back focus control layer between the lens layer and the sensor layer for each camera module, the wafer level camera module array having the same back focal length of every camera module is achieved without changing the thickness of the back focus control layer.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a wafer level camera module array according to an embodiment of the invention.

FIG. 2A is a cross-sectional view of the camera module A taken along a sectional line I-I′ depicted in FIG. 1.

FIG. 2B is a cross-sectional view of the camera module B taken along a sectional line I′-I″ depicted in FIG. 1.

FIG. 3 illustrates a camera module according to an exemplary embodiment in the invention.

### DESCRIPTION OF EMBODIMENTS

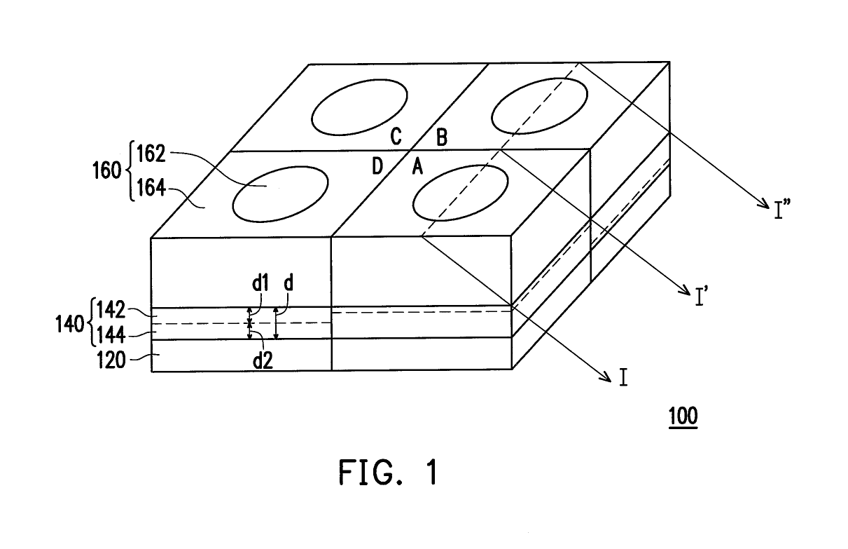

FIG. 1 is a schematic diagram of a wafer level camera module array according to an embodiment of the invention. Referring to FIG. 1, the wafer level camera module array 100 includes a plurality of camera modules in the present embodiment, and four camera modules A, B, C and D are exemplary for description herein. The wafer level camera module array 100 includes four camera modules A, B, C and D, and each of the camera modules includes a sensor layer 120, a back focus control layer 140 and a lens layer 160. Although only four camera modules are shown in FIG. 1, it should be noted that the number of the camera module in the wafer level camera module array is not limited thereto, and may be selected according to design requirement. The lens layer 160 is disposed on the back focus control layer 140, and the sensor layer 120 is disposed under the back focus control layer 140.

As the camera module, the lens layer 160 images an image on the sensor layer 120 through the back focus control layer 140, and the back focus control layer 140 adjusts a back focal length of the camera module. The sensor layer 120 is configured for detecting the image, so that an image sensing device such as a charge coupled device (CCD) or a complementary metal-oxide-semiconductor (CMOS) sensor may be implemented as the sensor layer 120. The back focus control layer 140 disposed between the lens layer 160 and the sensor layer 120 adjusts the back focal length of the camera module for converging the light on a surface of the sensor layer 120.

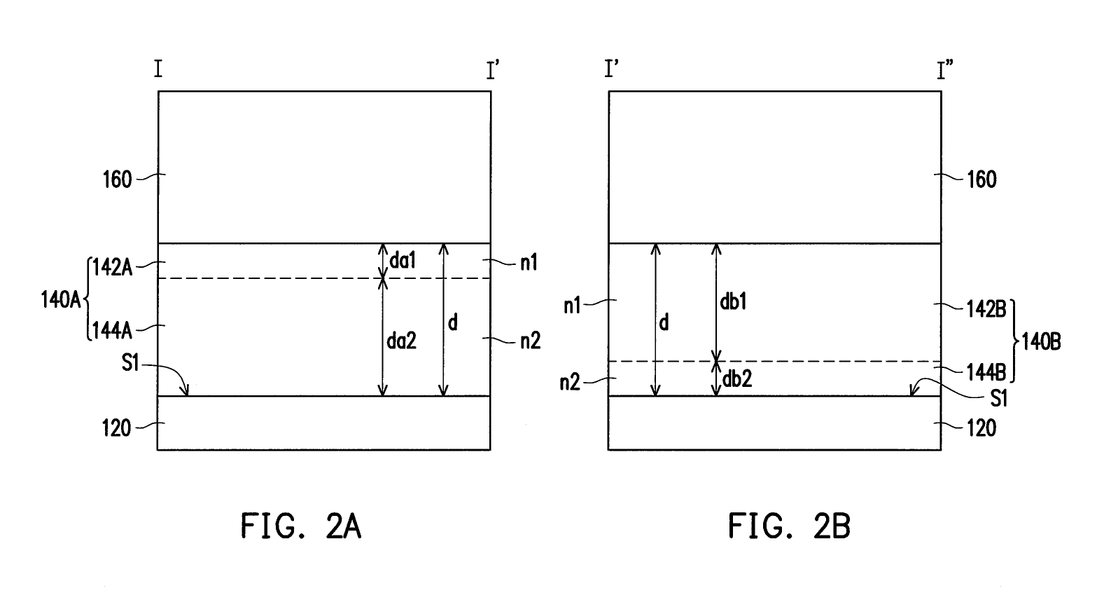

FIG. 2A is a cross-sectional view of the camera module A taken along a sectional line I-I′ depicted in FIG. 1. With reference to FIG. 2A, the back focus control layer 140A of the camera module A includes a first control layer 142A and a second control layer 144A and has a thickness d. The first control layer 142A has a first thickness da1 and a first refractive index n1, and the second control layer 144A has a second thickness da2 and a second refractive index n2 different from the first refractive index n1. The first control layer 142A and the second control layer 144A may be formed with different kinds of material to have different refractive indexes. That is to say, the material of the first control layer 142A is different from that of the second control layer 144A. Since the optical path length (OPL) is the product of the geometric length of the path of light and the refractive index of the material which light penetrates, by disposing and adjusting the first thickness da1 of the first control layer 142A and the second thickness da2 of the second control layer 144A, the OPL in the back focus control layer 140A is changed. The OPL of back focus control layer 140A of camera module A is shown below:

OPL=da1×n1+da2×n2

Therefore, the back focal length of the camera module A is also adjusted and can be equal to the thickness d of the back focus control layer. As the result, the light will be converged on a surface Si of the sensor layer 120.

However, the wafer level camera module array includes a plurality of camera modules, and different camera modules have different designs of the lens layer and different back focal lengths. Therefore, to keep all the camera modules with the same back focal length which equals to the thickness of the back focus control layer, the back focus control layers including the first control layer and the second control layer are applied herein. According to the description above, by adjusting the first thickness of the first control layer with the first refractive index and the second thickness of the second control layer with the second refractive index, various back focal lengths of camera modules may be changed to be the same.

According to the exemplary embodiment of the invention, the first thickness d1 of the first control layer 142 of one back focus control layer 140 is different from the first thicknesses of the first control layers of the other back focus control layers. Alternatively, the second thickness d2 of the second control layer 144 of the back focus control layer 140 is different from the second thicknesses of the second control layers of the other back focus control layers due to the different designs or the different fabrication processes of the lens modules. An example is illustrated below.

FIG. 2B is a cross-sectional view of the camera module B taken along a sectional line I′-I″ depicted in FIG. 1. According to the exemplary embodiment of the invention, the back focus control layer 140B of the camera module B includes a first control layer 142B and a second control layer 144B and also has the same thickness d as that of the camera module A. The first control layer 142B has a first thickness db1 and a first refractive index n1, and the second control layer 144B has a second thickness db2 and a second refractive index n2. It should be noted that the material used for the first control layer 142A in the camera module A is the same as the material used for the first control layer 142B in the camera module B, and the material used for the second control layer 144A in the camera module A is the same as the material used for the second control layer 144B in the camera module B in the present embodiment.

In the present exemplary embodiment, although the camera module A and the camera module B are arranged in the same wafer level camera module array, the camera module A and the camera module B are different camera modules. As the result, the camera module A and camera module B have different back focal lengths. Therefore, referring to the FIG. 2A and FIG. 2B, in order to change the different back focal lengths of the camera module A and the camera module B to be the same, the first thickness da1 of the first control layer 142A in the camera module A is different form the first thickness db1 of the first control layer 142B in the camera module B, and the second thickness da2 of the second control layer 144A in the camera module A is different from the second thickness db2 of the second control layer 144B in the camera module B.

Instead of changing the thicknesses of each back focus control layers 140, the first thickness da1 of the first control layer 142A and the second thickness da2 of the second control layer 144A of the camera module A are adjusted. Also, the first thickness db1 of the first control layer 142B and the second thickness db2 of the second control layer 144B of the camera module B are adjusted. Therefore, the OPLs of camera modules A and B are respectively changed, so that lights penetrate through both of the back focus control layers 140 in camera modules A and B are converged on the surface Si of the sensor layer 120 due to the designs of the first control layer 142A and 144A and the second control layer 142B and 144B.

Although the first thickness da1 and the second thickness da2 of the back focus control layer 140A of the camera module A are different from the first thickness db1 and the second thickness db2 of the back focus control layer 140B of the camera module B, the back focus control layers 140B and 140B of the camera modules A and B both have the same thickness d. That is to say, the camera modules A and B satisfy the following condition:

da1+da2=db1+db2=d

For the plurality of back focus control layers of the camera module array 100, the sum of the first thickness and the second thickness of one back focus control layer is substantially equal to the sum of the first thickness and the second thickness of another back focus control layer. From another perspective, for each of the back focus control layers, the sum of the first thickness of the first control layer and the second thickness of the second control layer is substantially equal to the thickness of the back focus control layer.

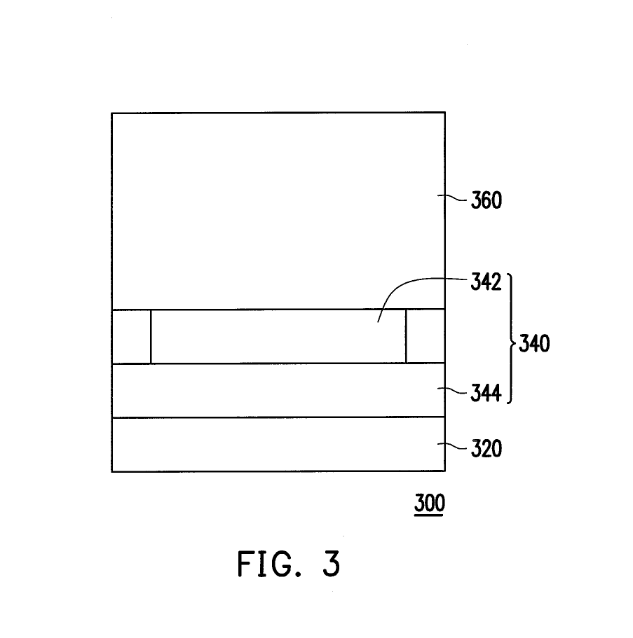

Although the back focus control layer may include the first control layer and the second control layer which are formed by various materials, in another exemplary embodiment, the back focus layer may be formed in different manner. FIG. 3 illustrates a camera module according to an exemplary embodiment in the invention. A camera module 300 includes a sensor layer 320, a back focus control layer 340 and a lens layer 360, and the back focus control layer 340 includes a first control layer 342 and a second control layer 344. In addition, the first control layer 342 may contain a gas material with a refractive index such as air. However, the invention is not limited thereto, and the first control layer 342 may contain a liquid material with another refractive index. Furthermore, according to another embodiment (not shown in FIG. 3), the first control layer may still be formed by the solid material, but the second control layer may contain a liquid material or a gas material.

The camera module A and the camera module B depicted in FIG. 2A and FIG. 2B are different camera modules according to the embodiment described above, and nevertheless, the invention is not limited thereto. Using the camera modules A, B, C and D in FIG. 1 as examples, in an exemplary embodiment of the invention, the camera modules A, B, C and D may be four different types of the camera modules. The first thickness of each type of camera module is different from the first thickness of another type of camera module, and the second thickness of each type of camera module is different from the second thickness of another type of camera module. As in another exemplary embodiment, the camera modules A and B may be the same type of the camera module, and the camera modules C and D may be another type of the camera module. The above description is to illustrate that, in the present invention, at least two types of the camera modules are arranged in the wafer level camera module array, but the arrangements and the numbers of the different camera modules are not limited thereto.

In summary, according to the exemplary embodiments of the invention, each of the camera modules includes a back focus control layer having the first control layer and the second control layer respectively formed by different materials. Although the thicknesses of the first control layer and the second control layer in each camera module are different from the thicknesses of the first control layer and the second control layer of another camera module, the thicknesses of each back focus control layer are the same. Therefore, the back focal lengths of all the camera modules arranged in the wafer level camera module array are the same as well, and fabrication difficulty and fabrication cost of the wafer level camera module array are reduced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A wafer level camera module array, comprising:
a plurality of camera modules arranged in an array, wherein each of the camera modules comprises a back focus control layer, and each of the back focus control layers has a same thickness and comprises:
a first control layer having a first thickness and a first refractive index; and
a second control layer having a second thickness and a second refractive index different from the first refractive index,
wherein for the plurality of back focus control layers, the first thickness of the first control layer of at least one back focus control layer is different from the first thicknesses of the first control layers of the other back focus control layers, or the second thickness of the second control layer of the at least one back focus control layer is different from the second thicknesses of the second control layers of the other back focus control layers.

2. The wafer level camera module array as claimed in claim 1, wherein for the plurality of back focus control layers, the first thickness of the first control layer of the at least one back focus control layer is different from the first thicknesses of the first control layers of the other back focus control layers, and the second thickness of the second control layer of the at least one back focus control layer is different from the second thicknesses of the second control layers of the other back focus control layers.

3. The wafer level camera module array as claimed in claim 1, wherein for the plurality of back focus control layers, a sum of the first thickness of the first control layer and the second thickness of the second control layer of one back focus control layer is substantially equal to a sum of the first thickness of the first control layer and the second thickness of the second control layer of another back focus control layer.

4. The wafer level camera module array as claimed in claim 1, wherein for each of the back focus control layers, a sum of the first thickness of the first control layer and the second thickness of the second control layer is substantially equal to the thickness of the back focus control layer.

5. The wafer level camera module array as claimed in claim 1, wherein each of the camera modules further comprises
a lens layer disposed on the back focus control layer; and
a sensor layer disposed under the back focus control layer,
wherein the lens layer images an image on the sensor layer through the back focus control layer, and the back focus control layer adjusts a back focal length of the camera module.
